(19) United States
(12) Patent Application Publication
(10) Pub. No.: US 2012/0044827 A1
(43) Pub. Date: Feb. 23, 2012

(54) COMMUNICATION METHOD AND APPARATUS IN MOBILE AD-HOC NETWORK

(76) Inventors: Jeong-Sik In, Gyeonggi-do (KR); Yong-Suk Park, Seoul (KR); Soon-Seob Han, Seoul (KR); Tae-Shik Shon, Gyeonggi-do (KR)

(21) Appl. No.: 13/266,699

(22) PCT Filed: Apr. 27, 2010
(86) PCT No.: PCT/KR10/02645

§ 371 Date: Oct. 27, 2011

(30) Foreign Application Priority Data
Apr. 27, 2009 (KR) 10-2009-0036698

(51) Int. Cl. H04B 7/212; H04W 24/00; H04W 72/04; H04L 12/26

(52) U.S. Cl. 370/252

(57) ABSTRACT

A communication method between nodes that have their own timers and have an equal start time of a frame for Time Division Multiple Access (TDMA) communication based on their timers in a mobile ad-hoc network, in which a node receives a timer value derived by a neighbor node on the basis of a transmission time, from the neighbor node, the node calculates a time offset indicative of a difference between a timer value derived on the basis of a time the node received the timer value, and the received timer value, and stores the time offset in a memory, and upon receiving a time value indicating a time related to inter-node TDMA communication from the neighbor node, the node corrects the received time value as a time value based on its timer using the time offset, and performs TDMA communication using the corrected time value.

### PRIORITY

This application is a National Phase Entry of PCT International Application No. PCT/KR2010/002645, which was filed Apr. 27, 2010, and claims priority to Korean Patent Application No. 10-2009-0036698, which was filed in the Korean Industrial Property Office on Apr. 27, 2009, the content of each of which is incorporated herein by reference.

### BACKGROUND OF THE INVENTION

1. Field of the Invention

The present invention relates generally to a mobile ad-hoc network, and more particularly, to a method for performing Time Division Multiple Access (TDMA) communication between nodes in a mobile ad-hoc network, and an apparatus thereof.

2. Description of the Related Art

Carrier Sense Multiple Access (CSMA) is a bandwidth allocation scheme mainly used in a mobile ad-hoc network. CSMA, in which bandwidth is allocated based on probability, is unsuitable for applications sensitive to transmission delay, such as voice communication and streaming.

Such transmission delay-sensitive applications need the schemes, in which bandwidth is allocated on a fixed basis, such as Time Division Multiple Access (TDMA), Frequency Division Multiple Access (FDMA), and Code Division Multiple Access (CDMA). Among them, FDMA or CDMA requires hardware support, but TDMA may operate with software. However, there are some technical difficulties in using TDMA, for example, in the mobile ad-hoc network that requires multi-hop communication, because there are no fixed central nodes, nodes move frequently, and not all nodes are present in a direct communication range.

Compared with voice call or streaming, applications for file or E-mail transmission are not sensitive to transmission delay due to instantaneous and irregular data generation. For such applications, CSMA is generally used because of the inefficiency of the fixed bandwidth allocation.

For TDMA communication, not only should communication nodes of both sides periodically set predefined transmission time slots, but also all other nodes within an interference range where they may interfere with the two nodes, should have information about the set time slots. Otherwise, overlapping transmission slots may be selected among the nodes existing in the interference range, so all nodes may undergo transmission disorders. In order for different nodes to exchange time-related information, unified references for time are needed. That is, timers should be adjusted among all nodes forming the network such that the respective nodes may always have the same timer value at the same time, which is referred to as “time synchronization.”

One of the existing schemes for synchronizing nodes in the network is to determine one reference node so that other nodes may adjust their timers to a timer of the reference node. That is, if the reference node transmits a packet with its time information recorded in it, or transmits a signal indicating its time information, then peripheral nodes receiving the information or signal may adjust their timers according to the received information or signal.

The above scheme is used in a system such as a cellular network, Wireless Local Area Network (WLAN), and Bluetooth®, in which terminals communicate with each other through one predetermined central node like a base station, an Access Point (AP), and a master node. In such a system, in order for a terminal to be allocated resources for data transmission, such as a TDMA time slot, frequency, code, and the like, the terminal should request the central node to allocate the transmission resources, and the central node should adjust resource allocation so as to prevent collisions from occurring among different terminals upon receiving the request from the terminal while maintaining information about the currently allocated resources.

The above-described conventional scheme is suitable when it can effectively control the possible interference existing among adjacent networks by time division, frequency division, frequency hopping, and the like, in the case where a particular central node is determined, each terminal always exists within a direct communication range of the central node, and different networks formed around different central nodes are spatially adjacent.

However, in the mobile ad-hoc network, all nodes can move randomly, so there is no particular central node. Even though a central node is selected, not all nodes may be present in the direct communication range of the central node. In this case, the entire network consisting of multiple hops should be synchronized to one central node, but it is difficult to maintain one central node in the process where networks are combined and divided.

Accordingly, the mobile ad-hoc network synchronizes time among nodes as illustrated in FIG. 1. In the case of FIG. 1 showing the conventional time synchronization, as a first group consisting of a first node 10, a second node 20 and a third node 30, and a second group consisting of a fourth node 40, a fifth node 50 and a sixth node 60 approach each other, some nodes in each group may be located in a direct communication range of the other group.

Referring to FIG. 1, the first node 10 and the sixth node 60 are central nodes that become time synchronization references, based on which nodes in each group perform TDMA communication.

Superframes of a first data stream 70 used in the first group and a second data stream 80 used in the second group are designated to perform TDMA communication. On the data streams 70 and 80, time intervals represented in the same patterns as the patterns indicating their associated nodes indicate that packets are transmitted by the pertinent nodes in the relevant intervals, and the packets are transmitted in node-specific fixed time slot intervals during the superframes. On the contrary, in CSMA, packets are transmitted at random times by a CSMA algorithm.

The superframe is a time period that is continuously repeated, and each node determines a starting point of this time period as a time 0. That is, if a period is T, a timer of each node repeats a time of 0 to T. In the state of FIG. 1, the three nodes 10, 20 and 30 in the first group and the three nodes 40, 50 and 60 in the second group are time-synchronized in each group, and cannot communicate or interfere with each other as the groups are far apart from each other. Since the intra-group synchronization has been made, the nodes in the groups always have the same timer values at the same time, so they can agree to transmit or not to transmit packets in a particular time interval. Hence, within the groups, the nodes can share time intervals not overlapping on the superframes without collisions, for TDMA transmission, but this condition may be broken when the two groups have approached within their communication ranges.

CSMA senses media before packet transmission, and delays the transmission upon sensing a packet being transmitted, thereby preventing collisions. In TDMA, however, since packets are transmitted unconditionally at a predetermined time, collisions may occur in the presence of a packet being transmitted, so both of the two packets cannot be received. In the conventional method for solving these problems, one of the existing two central nodes, i.e., the first node 10 and the sixth node 60, gives up the role of the central node after the two groups are combined, leaving only one central node, and then all nodes are synchronized with the remaining one central node and readjust TDMA transmission schedules, thereby preventing collisions. The collision-resolved superframe is illustrated on a third data stream 90. It is really important to resolve collisions by readjusting TDMA schedules, and unifying time synchronizations by integrating central nodes is needed to coordinate TDMA schedules among the groups distanced from each other.

The above-described conventional method can be used for small networks, and the nodes that do not move frequently. Otherwise, the conventional method can hardly be used. That is, in the mobile ad-hoc network where nodes move frequently and have no limitations on the radius of movement, nodes having different time references may frequently exist within a direct communication range. In this case, TDMA transmission schedules may collide among the nodes having different time references, so the TDMA transmission schedules should be united through the above-described process in the earliest possible time.

The TDMA transmission schedules need not collide only among the nodes existing in the mutual interference areas, but due to the continuous distribution of the nodes, time synchronizations may not be classified depending on the interference area. In other words, TDMA transmission schedules need not collide only within the interference areas, but time synchronizations should be unified all over the contiguous networks. To this end, the node that will give up the role of the central node should be determined by performing communication between two central nodes, and it may take a long time to determine the node if the distance between the two nodes is long.

Two piconets may neighbor each other, which require no communication. In this case, no path for communication may be established between the two central nodes distanced from each other. Even after the two central nodes are unified into one central node through an agreement, it takes a time until all nodes are synchronized to a new central node. Thus, the nodes may experience significant communication disorders for a considerable period of time.

After multiple node or piconet groups gather to form one overall synchronized large network, the central node may suddenly leave the network. In this case, a big issue is how to determine a new central node. In the conventional approach, all nodes generate random numbers like throwing dice and then a central node is selected probabilistically depending on the generated values. The use of this approach likely generates two or more central nodes or no central node depending on the probability values used. If several central nodes occur, the above process of unifying the central nodes into one is needed again. On the contrary, no central node may occur despite the passage of time. In either case, significant network performance degradation occurs.

### SUMMARY OF THE INVENTION

Therefore, the present invention has been designed to address at least some of the aforementioned limitations and problems occurring in the prior art and the present invention provides at least the advantages as described below.

Accordingly, an aspect of the present invention is to address at least the above-mentioned problems and/or disadvantages and to provide at least the advantages described below. Accordingly, an aspect of the present invention provides a method and apparatus for enabling efficient TDMA communication in a mobile ad-hoc network.

Another aspect of the present invention provides a method and apparatus for facilitating stable combined communication of CSMA and TDMA in a mobile ad-hoc network.

A further aspect of the present invention provides a method and apparatus for ensuring stable and effective voice call and multimedia streaming in a mobile ad-hoc network.

In accordance with one aspect of the present invention, there is provided a communication method between nodes that have their own timers and are equal in start time of a frame for Time Division Multiple Access (TDMA) communication based on their timers in a mobile ad-hoc network, in which a node receives a timer value derived by a neighbor node on the basis of a transmission time, from the neighbor node, the node calculates a time offset indicative of a difference between a timer value derived on the basis of a time the node received the timer value, and the received timer value, and stores the time offset in a memory, and upon receiving a time value indicating a time related to inter-node TDMA communication from the neighbor node, the node corrects the received time value as a time value based on its timer using the time offset, and performs TDMA communication using the corrected time value.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a diagram illustrating conventional inter-node TDMA communication;

FIG. 2 is a diagram illustrating a communication apparatus of a node according to an embodiment of the present invention;

FIG. 3 is a diagram illustrating a structure of an ad-hoc network according to an embodiment of the present invention;

FIG. 4 is a diagram illustrating frames for nodes according to an embodiment of the present invention;

FIG. 5 is a diagram illustrating a structure of a time schedule message according to an embodiment of the present invention;

FIG. 6 is a diagram illustrating an operation process of a processor according to an embodiment of the present invention;

FIG. 7 is a diagram illustrating an operation process of a processor according to another embodiment of the present invention;

FIG. 8 is a diagram illustrating an inter-node message transmission process according to an embodiment of the present invention; and

FIG. 9 is a diagram illustrating data streams for nodes according to another embodiment of the present invention.

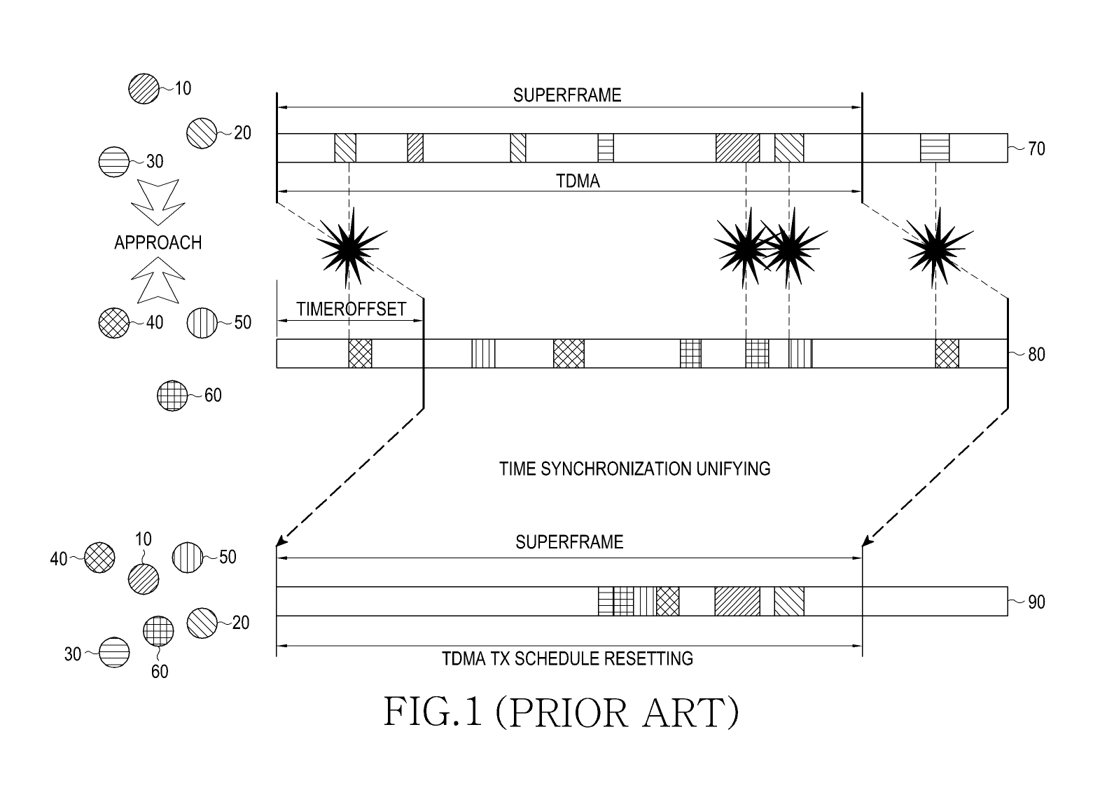

### DETAILED DESCRIPTION OF THE EMBODIMENTS OF THE PRESENT INVENTION

Various embodiments of the present invention will now be described in detail with reference to the accompanying drawings. This present invention may, however, be embodied in many different forms and should not be construed as limited to the embodiments set forth herein. Rather, these embodiments are provided so that this disclosure will be thorough and complete and will fully convey the scope of the present invention to those skilled in the art. Throughout the drawings, the same drawing reference numerals will be understood to refer to the same elements, features and structures. In the following description, a detailed description of known functions and configurations is omitted for clarity and conciseness.

According to the present invention, a mobile ad-hoc network consists of a plurality of wireless communication nodes having mobility. The wireless communication nodes (hereinafter “nodes”) may include, for example, mobile communication terminals, notebook computers, and Personal Digital Assistances (PDAs). One node may serve as an independent node, or may be included in a micro-scale network, or a piconet, consisting of a master node and its one or more slave nodes, as a “master node” or a slave node. Because the independent node may be considered a master node with no slave node, the term master node as used herein may be construed to include an independent node with no slave node. The mobile ad-hoc network may repeatedly undergo separation, integration and change as the independent nodes or piconets move.

A master node may directly communicate with its slave nodes, and other master nodes in its communication range. In both cases, the master node may use CSMA and TDMA together according to the method of the present invention. It is advantageous to use TDMA for the traffic that occurs regularly and is sensitive to transmission delay, and CSMA for the traffic that occurs irregularly and is not sensitive to transmission delay.

In accordance with an embodiment of the present invention, TDMA transmission scheduling may be achieved by information exchange between master nodes, and it is preferable that slave nodes are synchronized with a master node and operate depending on an instruction from the master node. If a slave node, which needs a time slot for TDMA communication, requests the master node to allocate the time slot, the master node determines a requested time slot taking into account the time slots used by the nearby master nodes or independent nodes, notifies the nodes in a certain range of the determined time slot, and then allocates it to the requesting slave node. In the following description, the term “node” as used herein refers to an independent node or a master node with one piconet. If there is a significant difference between an interference range of a master node and an interference range of a slave node due to the broad physical space occupied by a piconet, the master node cannot make a slot reservation on behalf of the slave node, so even the slave node may operate like one independent node.

In the present invention, each node identifies another node's time slot schedule while maintaining its own time reference, instead of all nodes adjusting time synchronization on the basis of a timer of a particular node. For this purpose, a concerned node calculates a time difference between its timer and a timer of another node, applies the calculated time difference to a time value received from a neighbor node, and converts the received time value into a time value based on its timer, so the nodes may accurately exchange information about each other's time without a single reference time.

In other words, a node receives a neighbor node's time information from the neighbor node, calculates a time offset between its timer and the neighbor node's timer using the received time information, and corrects a time value of the time slot that has been reserved or used by the neighbor node, on the basis of its timer using the calculated time offset, thereby accurately identifying a time slot interval appointed to the neighbor node without a synchronization process for a particular reference time. The node may specify its desired time slot interval.

The biggest problem that may occur when TDMA is used in the mobile ad-hoc network is that, as described above, the frequent change in reference node due to the movement of nodes may result in excessive overhead and time delay. The present invention, however, removes the overhead and time delay, ensuring efficient operation of TDMA despite the frequent movement of nodes.

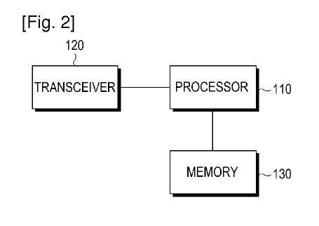

An embodiment of the present invention will be described with reference to FIGS. 2 to 9. In the following description, each of a timer value and a time value may be construed to represent a particular time rather than a time interval.

First, a structure of a network apparatus provided in each node performing communication in the mobile ad-hoc network will be described with reference to FIG. 2. According to an embodiment of the present invention, the network apparatus includes a processor 110, a transceiver 120, and a memory 130.

The processor 110 controls the transceiver 120 and the memory 130 depending on the node's communication operation in the mobile ad-hoc network. The processor 110 includes a timer counting the time.

The transceiver 120, under the control of the processor 110, transmits and/or receives data via a communication link formed between nodes, and processes the data accordingly.

The memory 130 stores a variety of information that the node needs in performing communication in the mobile ad-hoc network. According to the present invention, the memory 130 may also store time slot information for TDMA communication. The time slot information includes information about a time slot of the pertinent node and information about a time slot for each of neighbor nodes, and is stored in the form of a time slot table according to an embodiment of the present invention. The term “neighbor nodes” refers to nodes that are located around the pertinent node and may interfere with the pertinent node, and the neighbor nodes may be determined by various criteria, such as their transmit power, transmission channel characteristics, and physical transmission schemes. For example, the neighbor nodes may be set to include neighbor nodes that can be connected to the pertinent node by 1 to n hop.

In accordance with the present invention, the processor 110 broadcasts the time slot information stored in the memory 130 by means of the transceiver 120. Upon receipt of time slot information from a neighbor node, the processor 110 calculates a time offset between its timer and the neighbor node's timer using the neighbor node's time information included in the time slot information. The processor 110 corrects time values included in time slot information received from neighbor nodes as time values based on its timer using the time offsets, and stores the corrected time values. Lengths of the time slots are not corrected.

The time slot information is information about the time slot that the pertinent node is allocated to transmit and receive data by TDMA, and includes identification information of the pertinent node, and start time and length information of each time slot specified for the pertinent node on one frame. Items stored in a time slot table representing such time slot information are as shown in Table 1 below.

TABLE 1

| | | | | | |
|---|---|---|---|---|---|
| Node | Number | Time | Time Slot | Time | Version |
| Address | of | Offset | Start Time | Slot | Information |
| | Hops | | | Length | |

Referring to Table 1, in the time slot table, each entry is generated to correspond to each time slot specified for an arbitrary node. For example, when one node uses multiple separated time slots, multiple entries for the same node may be included in one table. The Node Address field represents an address of the node that reserved the slot in order to indicate information about a certain node, which corresponds to the entry, and may be used as identification information of the node. The Number of Hops field is information representing the distance corresponding to the number of hops between the pertinent node and a neighbor node, and the number of hops of the pertinent node is 0. The Time Offset field indicates a time difference between the pertinent node's timer and the neighbor node's timer. The Time Slot Start Time field is a value representing the time at which the time slot corresponding to the entry starts based on the starting point of the frame, and the Time Slot Length field represents a length, or time interval, of the time slot. The Version Information field is information representing an update level of the information included in the entry, and indicates how much latest information the entry has.

The time slot table has no entries when the node is initially booted. However, if time slot information is received from another node or the time slot to be used in the pertinent node is reserved after the booting, the processor 110 generates table entries corresponding thereto. When the entries of the time slot table are generated, the processor 110 broadcasts time slot information corresponding to the contents of the current time slot table periodically or on a randomly repeated basis.

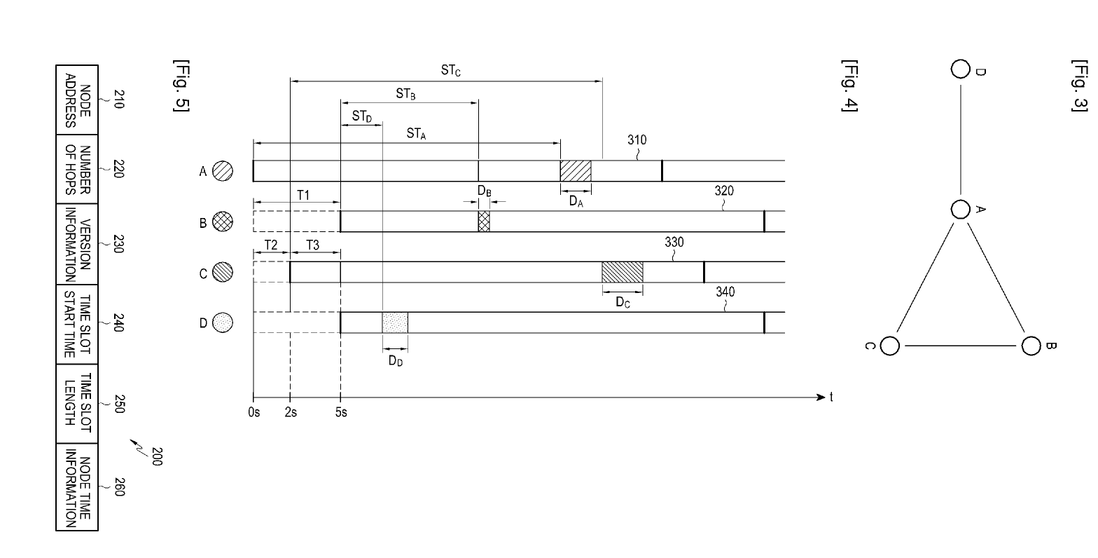

An example of a process of creating, updating and storing the time slot table will be described with reference to FIGS. 3 and 4. FIG. 3 shows a mobile ad-hoc network consisting of four nodes: a node A, a node B, a node C and a node D. FIG. 4 shows frames corresponding to the respective nodes: a frame A 310, a frame B 320, a frame C 330, and a frame D 340.

Referring to FIG. 3, each of the node A, the node B, the node C and the node D has the network transmission apparatus illustrated in FIG. 2. The node A, the node B and the node C are connected to each other by one hop, and the node A and the node D are also connected to each other by one hop. However, the node B and the node C are connected to the node D through the node A. Here, the node B and the node C are not located in a direct communication range of the node D, and vice versa. The number of hops between the node D, and the node B and the node C is 2.

Referring to FIG. 4, time slot intervals occupied by the node A, the node B, the node C and the node D are represented in the same patterns as those of the node A, the node B, the node C and the node D in the frame A 310, the frame B 320, the frame C 330 and the frame D 340. The frame A 310, the frame B 320, the frame C 330 and the frame D 340 start in their associated nodes at the times agreed upon between the nodes. In other words, frame periods for TDMA communication are the same in all nodes, and frame start times are also the same among the nodes. For example, if a frame period is 10 seconds, frame start times may be 0 seconds, 10 seconds, 20 seconds, 30 seconds, 40 seconds and 50 seconds in every minute on the basis of each node's timer. If timers of all nodes start counting on the basis of the same time, inter-node time synchronization is not needed, but a time difference occurs between timers of the nodes because each node's timer may start counting on the basis of a different time. Therefore, even if frames start at a predetermined time, frame start times of the respective nodes may be substantially different from each other.

In the mobile ad-hoc network constructed as described above, each node creates entries of the time slot table if it receives time slot information from another node or reserves a time slot to be used in the node after booting. In this embodiment, a process of creating and updating a time slot table will be described on the assumption that the node A, the node B, the node C and the node D determine their time slots to be used, in order, on the basis of an arbitrary time difference.

Referring to FIG. 4, the frame A 310, the frame B 320 and the frame C 330 corresponding to their associated nodes are different in substantial starting point, and the frame D 340 starts at time same time as the frame B 320. That is, timers of the node A, the node B and the node C have different time references, while timers of the node B and the node D have the same time reference. For the respective nodes, time slot start times are ST_{A}, ST_{B}, ST_{C} and ST_{D} on the basis of starting points of their associated frames, and lengths of the time slots are D_{A}, D_{B}, D_{C} and D_{D}.

After each node A, B and C has booted, if the node A decides its TDMA time slot for the first time as needed, the information is recorded in a time slot table of the node A, which is shown in Table 2 below.

TABLE 2

| | Number | | | Time | |
|---|---|---|---|---|---|
| Node | of | Time | Time Slot | Slot | Version |
| Address | Hops | Offset | Start Time | Length | Information |
| A | 0 | 0 | ST_{A} | D_{A} | 0 |

In Table 2, the node address is represented by an alphabetic character instead of an Internet Protocol (IP) address, for convenience. Since the created time slot table entries are information about a time slot of the pertinent node, the number of hops and the time offset are both 0, and because they are first created entries, the version information is also 0. In addition, the node A determines a desired time at random because there are no peripheral nodes presently that have reserved TDMA time slots, and the determined time is ST_{A} in the above example. For a better understanding of the present invention, the time slot start time is represented by ST_{A} in this embodiment. However, the time slot start time may be a timer value for the time counted by the node A's timer, and the same may be applied in ST_{B}, STc and ST_{D}.

Thereafter, the node A configures a TDMA schedule message including the entry information of Table 2 and broadcasts the message, thereby broadcasting time slot information. The TDMA schedule message may be broadcasted only to neighbor nodes. An example of the TDMA schedule message is illustrated in FIG. 5. Referring to FIG. 5, a TDMA schedule message 200 includes a node address 210, a number-of-hops 220, version information 230, a time slot start time 240, a time slot length 250 and node time information 260.

Before configuring the TDMA schedule message 200, the processor 110 increases version information of the entry related to the pertinent node in a time slot table one by one. In the presence of the entry, the processor 110 keeps the version information of the entry associated with another node intact. The changed version information is included in the TDMA schedule message 200. The Time Offset field in the time slot table is not included in the TDMA schedule message 200 because it is a value that the pertinent node has calculated by receiving node time information of a neighbor node.

The node time information 260 is information about a timer value used in the pertinent node, and this information is used to calculate a time offset between nodes. Thus, a timer value included in the node time information 260 is determined based on a timer value for the time at which the TDMA schedule message 200 is transmitted. For example, the timer value may be a transmission time of the TDMA schedule message, or a time value determined by subtracting a particular time from the transmission time.

While the node time information 260 is carried by the TDMA schedule message 200 in the example of FIG. 5, the node time information 260 may be broadcasted as a separate message. In this case, upon receipt of the node time information 260, the node calculates a time offset between the node itself and an arbitrary node that transmitted the node time information 260, and then stores the time offset in the memory 230. The time offset may be stored in the slot time table. Upon receiving a TDMA schedule message from an arbitrary node, the node corrects all time slot start time values included in the TDMA schedule message using the stored time offset corresponding to the arbitrary node.

If the node A broadcasts a TDMA schedule message including the information defined in Table 1, the node B and the node C can receive the TDMA schedule message. Hence, the node B and the node C update their own time slot tables, determining that the node A that transmitted the TDMA schedule message is a neighbor node.

Because there are no entries in their time slot tables at the present time, the node B and the node C generate first entries after receiving the TDMA schedule message from the node A, and then configure time slot tables shown in Tables 3 and 4, respectively. Table 3 represents the time slot table of the node B, and Table 4 represents the time slot table of the node C.

TABLE 3

| | Number | | | Time | |
|---|---|---|---|---|---|
| Node | of | Time | Time Slot | Slot | Version |
| Address | Hops | Offset | Start Time | Length | Information |
| A | 1 | −T1 | ST_{A} − T1 | D_{A} | 1 |

TABLE 4

| | Number | | | Time | |
|---|---|---|---|---|---|
| Node | of | Time | Time Slot | Slot | Version |
| Address | Hops | Offset | Start Time | Length | Information |
| A | 1 | −T2 | ST_{A} − T2 | D_{C} | 1 |

Referring to Tables 3 and 4, in the time slot tables of the node B and the node C, time offsets for node A are −T1 and −T2, respectively. Such time offsets are calculated using the node time information about the node A, included in the TDMA schedule message 200.

That is, the value determined by subtracting a timer value of the node that transmitted the TDMA schedule message 200, from a timer value derived on the basis of the time the pertinent node received the message becomes the time offset. For example, if the transmission time of the TDMA schedule message 200 is used as node time information, for each of the node B and the node C, the value determined by subtracting the transmission time from the reception time of the TDMA schedule message 200 is the time offset value. Therefore, the time offset −T1 for the node A in the time slot table of the node B means that a timer value of the node B is determined by adding −T1 to the timer value of the node A at an arbitrary time.

The number-of-hops entry for the node A is 1 in the time slot tables of Tables 3 and 4, because the node B and the node C have directly received messages from the node A.

The time slot start time of the node A is ST_{A}, which is a value based on the node A's timer as described above. The node B should change the time slot start time for the node A to a value based on its timer and store the changed value, in order to identify the exact time the time slot used by the node A starts, and to determine whether the time slot interval is maintained. Therefore, the node B stores the value determined by adding the time offset to the time slot start time received from the node A in the relevant entry of the time slot table as a time slot start time. That is, ST_{A}−T1 is stored as shown in Table 3. The same is applied in the node C, so ST_{A}−T2 is stored in the relevant entry of the time slot table of the node C as the time slot start time as shown in Table 4.

Since a length of the time slot is constant regardless of the time offset of each node, the value recorded in the received TMDA schedule message is stored intact in this field.

Thereafter, if needed, the node B may also determine its TDMA time slot referring to its slot table. The node B may perceive that a time interval D_{A} starting from the time ST_{A}−T1 based on its timer has been reserved by the node A. Thus, the node B randomly specifies a needed time interval out of the remaining time interval except for the reserved time interval as its time slot interval, and generates a new entry in the time slot table. Referring to FIG. 4, the node B reserves a time interval D_{B} starting from the time ST_{B} as its time slot interval. As a result, the time slot table of the Node B may include two entries as shown in Table 5.

TABLE 5

| | Number | | | Time | |
|---|---|---|---|---|---|
| Node | of | Time | Time Slot | Slot | Version |
| Address | Hops | Offset | Start Time | Length | Information |
| A | 1 | −T1 | ST_{A} − T1 | D_{A} | 1 |
| B | 0 | 0 | ST_{B} | D_{B} | 0 |

Subsequently, the two entries of Table 5 are included in the TDMA schedule message of the node B. Upon receiving this message, the node A and the node C add the entries for the node B in their tables, and values of these items are determined in the manner described above. The time slot tables of node A and node C are configured as shown in Tables 6 and 7, respectively.

TABLE 6

| | Number | | | Time | |
|---|---|---|---|---|---|
| Node | of | Time | Time Slot | Slot | Version |
| Address | Hops | Offset | Start Time | Length | Information |
| A | 0 | 0 | ST_{A} | D_{A} | 1 |
| B | 1 | T1 | ST_{B} + T1 | D_{B} | 1 |

TABLE 7

| | Number | | | Time | |
|---|---|---|---|---|---|
| Node | of | Time | Time Slot | Slot | Version |
| Address | Hops | Offset | Start Time | Length | Information |
| A | 1 | −T2 | ST_{A} − T2 | D_{C} | 1 |
| B | 1 | T3 | ST_{B} + T3 | D_{B} | 1 |

Thereafter, the node C may also determine a time interval D_{C} starting from the time slot start time ST_{C} as its time slot interval by the same process, and update it in a time slot table of a neighbor node. The time slot tables that the three nodes can finally get through this process can be shown as in Tables 8, 9 and 10. Table 8 shows a time slot table of the node A, Table 9 shows a time slot table of the node B, and Table 10 shows a time slot table of the node C.

TABLE 8

| | Number | | | Time | |
|---|---|---|---|---|---|
| Node | of | Time | Time Slot | Slot | Version |
| Address | Hops | Offset | Start Time | Length | Information |
| A | 0 | 0 | ST_{A} | D_{A} | 1 |
| B | 1 | T1 | ST_{B} + T1 | D_{B} | 1 |
| C | 1 | T2 | ST_{C} + T2 | D_{C} | 1 |

TABLE 9

| | Number | | | Time | |
|---|---|---|---|---|---|
| Node | of | Time | Time Slot | Slot | Version |
| Address | Hops | Offset | Start Time | Length | Information |
| A | 1 | −T1 | ST_{A} − T1 | D_{A} | 1 |
| B | 0 | 0 | ST_{B} | D_{B} | 1 |
| C | 1 | −T3 | ST_{C} − T3 | D_{C} | 1 |

TABLE 10

| | Number | | | Time | |
|---|---|---|---|---|---|
| Node | of | Time | Time Slot | Slot | Version |
| Address | Hops | Offset | Start Time | Length | Information |
| A | 1 | −T2 | ST_{A} − T2 | D_{C} | 1 |
| B | 1 | T3 | ST_{B} + T3 | D_{B} | 1 |
| C | 0 | 0 | ST_{C} | D_{C} | 1 |

The foregoing process is one example. Specifically, the slot reservation order does not have to be fixed, not all nodes need to have TDMA time slots, and one node may have two or more TDMA time slots if needed.

Through the above-described process, each node can identify all the TDMA time slots that peripheral nodes have reserved, based on its own timer. This information may be used to select TDMA slots to be additionally reserved later as needed such that they may not overlap other already reserved TDMA slots, and also used to prevent the packets transmitted during CSMA packet transmission from overlapping in TDMA slot intervals. To transmit a CSMA packet, a data transmission node determines whether a channel is in an idle state, and transmits the packet if the channel is in the idle state. Otherwise, the data transmission node performs backoff according to a predetermined algorithm and then rechecks the channel status to determine whether to transmit the packet at the present time. Although various kinds of backoff algorithms are available, the existing CSMA algorithm may be used intact in the present invention. However, the existing algorithm, when it has decided to transmit a packet, calculates a packet transmission completion time based on a length of the packet, and re-performs backoff at the time the TDMA time slot expires, abandoning the transmission, if the packet transmission completion time overlaps even part of the reserved TDMA time slot.

Each node, which has TDMA schedules of neighbor nodes in the form of a table, may prevent packet collision by referring to the table when determining its TDMA time slot or transmitting a CSMA packet. An interference phenomenon causing packet collision may occur in a distance of one or more hops. Considering this, the time slot table may be transmitted up to the distance of one or more hops in the present invention.

In FIG. 3 the node B is in a direct transmission distance from the node A, and the node D that is not in a direct transmission distance from the node C. The node D can receive a TDMA schedule message from the node A, so it can receive the node A's time information and time slot table. Based on this, the node D can determine that the node A, the node B and the node C are located around the node D itself, and identify the TDMA time slot schedules of the respective nodes. Since the node D directly receives information from the node A, its time slot table can be configured as shown in Table 11 below, with reference to FIG. 3.

TABLE 11

| | Number | | | Time | |
|---|---|---|---|---|---|
| Node | of | Time | Time Slot | Slot | Version |
| Address | Hops | Offset | Start Time | Length | Information |
| A | 1 | −T1 | ST_{A} − T1 | D_{A} | 2 |
| B | 2 | −T1 | ST_{B} | D_{B} | 1 |
| C | 2 | −T1 | ST_{C} + T2 − T1 | D_{C} | 1 |

The number of hops for the node A is recorded as 1 in the time slot table, and the number of hops for the nodes B and C is recorded as 2 by increasing the number of hops included in the TDMA schedule message by one hop, since the nodes B and C are not in a direct transmission distance from the node D though they are in a 1-hop distance from the node A. If the node D approaches the nodes B and C, entering their direct transmission distances, it can receive TDMA schedule messages directly from these nodes. Thus, the number of hops for these nodes is changed to 1.

The time offsets for all nodes are indicated as T1 in Table 11, because the time offset value is determined by timer values of the pertinent node and its neighbor nodes. In addition, since time values included in the TDMA schedule message are the values that have already been determined based on the timer of the node that transmitted the TDMA schedule message, even though the time values included in the TDMA schedule message are corrected using the time offset between the node transmitting the TDMA schedule message and the node receiving the TDMA schedule message, no calculation error may occur and the node receiving the TDMA schedule message can determine the exact time. In this manner, each node may record in the time slot table the TDMA time slot schedule information for the nodes that are located more than 1 hop away from the node.

Thereafter, when the node D sets its TDMA time slot as needed, the node D can recognize that the time interval D_{A} starting from the time ST_{A}−T1 has been reserved by the node A, based on its timer, referring to its slot table. In addition, based on its timer, the node D may perceive that the time interval D_{B} starting from the time SI_{B} has been reserved by the node B and the time interval D_{C} starting from the time ST_{C}+T2−T1 has been reserved by the node C. The node D specifies its desired time slot interval in the frame interval that is not occupied by the nodes A, B and C. Referring to FIG. 4, the node D may reserve a time slot that lasts for D_{D} beginning from ST_{D} based on its timer, and based thereon, the time slot table is updated as shown in Table 12.

TABLE 12

| | Number | | | Time | |
|---|---|---|---|---|---|
| Node | of | Time | Time Slot | Slot | Version |
| Address | Hops | Offset | Start Time | Length | Information |
| A | 1 | −T1 | ST_{A} − T1 | D_{A} | 2 |
| B | 2 | −T1 | ST_{B} | D_{B} | 1 |
| C | 2 | −T1 | ST_{C} + T2 − T1 | D_{C} | 1 |
| D | 0 | 0 | ST_{D} | D_{D} | 0 |

In the present invention, the distance from a location of the node whose time slot schedule information needs to be maintained in the time slot table to avoid the inter-node interference may be determined taking into account the performance and standards of the communication hardware and the channel environments. That is, the range of peripheral nodes, which is to be stored in the time slot table on the basis of the pertinent node, can be determined considering many environments. The range of peripheral nodes, to be stored in the time slot table, may be inconsistent with the range of nodes, to which the pertinent node will refer when allocating time slots.

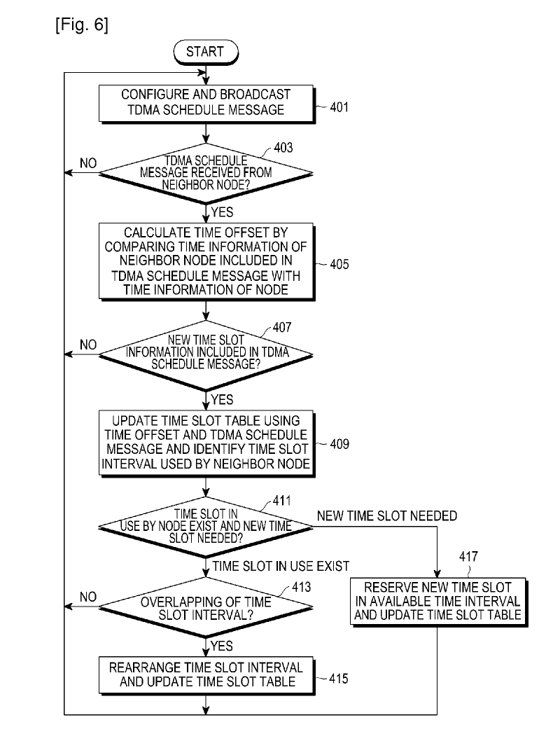

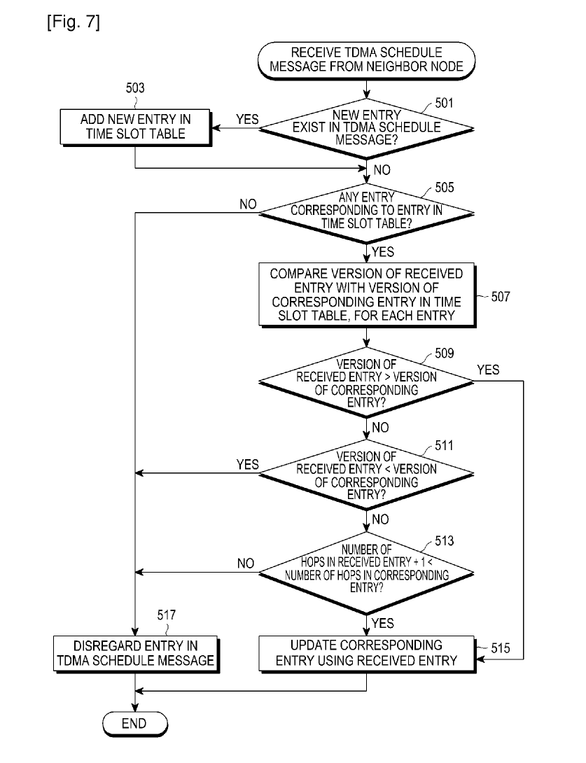

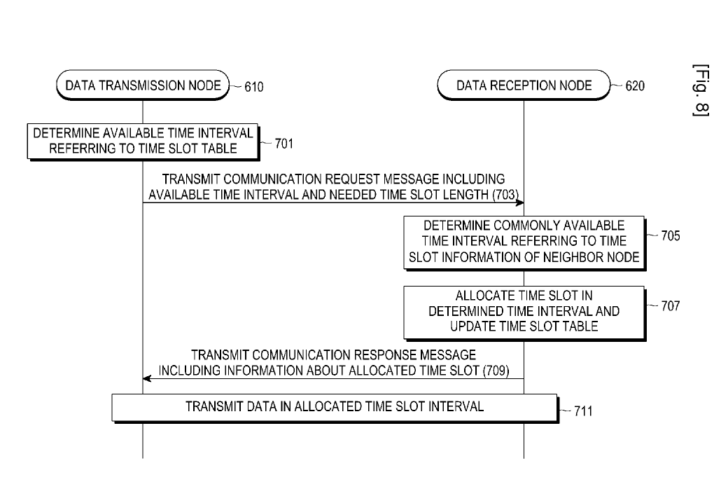

An operation process of the processor 110 to create, transmit and update time slot information in the form of a time slot table and allocate time slots based on the time slot information as described above will be described with reference to FIGS. 6 and 7.

Referring to FIG. 6, the processor 110 configures a TDMA schedule message referring to a time slot table stored in the memory 130 and broadcasts the message in step 401. Preferably, the TDMA schedule message may be broadcasted periodically, and in an embodiment of the present invention, this message is broadcasted using CSMA. In step 403, the processor 110 determines whether a TDMA schedule message is received from a neighbor node.

Upon receipt of the TDMA schedule message, the processor 110 calculates a time offset by comparing the neighbor node's time information included in the TDMA schedule message with time information of the pertinent node in step 405. In step 407, the processor 110 determines whether new time slot information is included in the TDMA schedule message by checking the time slot table stored in the memory 130, and the received TDMA schedule message. The new time slot information is determined to be included, if a new entry is included in addition to the entries of the time slot table stored in the memory 130. Also, the inclusion may be determined, if the entry included in the TDMA schedule message has the latest version or a smaller number of hops compared with the stored entry even though an entry for the same time slot exists in the time slot table.

In this update process of determining whether new time slot information is included in the TDMA schedule message, the processor 110 may either maintain the latest time slot information, or combine in one entry, the same time slot information of the same node, which is received from several neighbor nodes. As an example, the node A receives time slot information of the node B from both the nodes B and C. In this way, a node may receive the same time slot information of the same node from multiple neighbor nodes, and as the node density increases, the node may receive information about the same time slot from more neighbor nodes.

If new time slot information is included in the TDMA schedule message, the processor 110 updates the time slot table using the time offset calculated in step 405 and the new time slot information included in the TDMA schedule message in step 409.

The process of updating the time slot table by determining whether new time slot information is included in the TDMA schedule message is shown in FIG. 7. Referring to FIG. 7, upon receiving a TDMA schedule message from a neighbor node, the processor 110 determines in step 501 whether a new entry is included in the TDMA schedule message in addition to the entries of the time slot table stored in the memory 130. In the absence of the new entry, the processor 110 proceeds to step 505. In the presence of the new entry, the processor 110 adds the new entry in the time slot table in step 503, and then proceeds to step 505.

In step 505, the processor 110 determines whether the entries included in the TDMA schedule message include an entry corresponding to the entry in the time slot table stored in the memory 130.

The criteria for determining new entries or corresponding entries may include a node address, a time slot start time, and a time slot length. The time slot start time existing in each entry included in the TDMA schedule message is changed to a time value based on a timer of the pertinent node using the time offset calculated in step 405, and then compared with the time slot start time in the entry of the time slot table.

If an entry corresponding to the entry included in the TDMA schedule message does not exist in the memory 130, the processor 110 disregards the remaining entries included in the TDMA schedule message in step 517. However, if an entry corresponding to the entry included in the TDMA schedule message exists in the memory 130, the processor 110 compares a version of the received entry with a version of a corresponding entry in the time slot table on an entry pair basis in step 507.

Since each node increases version information of an entry for its time slot before transmitting the TDMA schedule message, an entry with a greater version is a more recent entry. Thus, if a version of the received entry is greater than a version of the corresponding entry in step 509, the processor 110 updates the corresponding entry in the time slot table using the received entry in step 515. However, if the version of the received entry is not greater than the version of the corresponding entry, the processor 110 determines in step 511 whether the version of the received entry is less than the version of the corresponding entry, and if so, disregards the relevant entry in step 517.

If the version of the received entry is not less than, i.e., is equal to the version of the corresponding entry in step 511, the processor 110 compares a value obtained by increasing the number of hops in the received entry by 1 with the number of hops in the corresponding entry of the time slot table in step 513. If the number of hops in the corresponding entry is greater than the increased value, the processor 110 updates the corresponding entry in the time slot table using the received entry in step 515. However, if the number of hops in the corresponding entry is less than the increased value, the processor 110 disregards the received entry in step 517.

The processor 110 deletes the entry that has not been updated for a predetermined time, among the entries in the time slot table.

Turning back to step 409 in FIG. 6, after updating the time slot table through the process of FIG. 7, the processor 110 determines a time slot interval used by the peripheral node, i.e., the place where the time slot interval corresponding to each entry included in the time slot table is located in the frame.

In step 411, the processor 110 determines whether there is a time slot being used by the pertinent node, or whether a new time slot needs to be allocated. If a new time slot needs to be allocated, the processor 110 reserves a new time slot in the available time interval, and updates the time slot table in step 417. Thereafter, the processor 110 returns to step 401. The processor 110 may transmit and receive data in the newly reserved time slot interval.

If the time slot being used by the pertinent node exists in step 411, the processor 110 determines in step 413 whether time slot intervals of the pertinent node and its neighbor node overlap. If so, the processor 110 rearranges the time slot interval by communicating with the neighbor node and updates the time slot table according thereto in step 415, and then returns to step 401. The processor 110 transmits and receives data in the rearranged time slot interval.

This is because in some cases, the two nodes may simultaneously select overlapping time slots. If there is a sufficient time difference between the times the two nodes select time slots, another node selects its time slot after a time slot of one node is selected and then its information is completely propagated within a predetermined range. Thus, the node may select its time slot excluding all of the already selected time slot intervals. However, if the time difference is insufficient, the nodes may select overlapping time slots.

If both of the two nodes that selected the overlapping time slots change their time slots, collisions are likely to occur again. Therefore it is more efficient for only one of the two nodes to change the time slot. According to the present invention, a node that has sensed a collision compares an address of the corresponding node that caused the collision with its address, and changes its time slot if its address is greater. Since every node has a different address, using this method always allows only one of the two nodes to attempt a change of the time slot during the collision. However, in this case, a node with a smaller address is always advantageous in selecting the time slot. Accordingly, the following algorithm may be used. Also, a node that has sensed a collision may be adapted to compare an address of the corresponding node that caused the collision with its address, and change its time slot if its address is smaller.

If the most significant bit of the result value determined by subtracting the corresponding node's address from its own address is 1 and the remaining bits are all 0, the result value determined by subtracting its own address from the corresponding node's address is also the same. Thus, only in this case, a node with a greater address value changes the time slot. In the other cases, only the node changes the time slot, for which the most significant bit of the result value determined by subtracting the corresponding node's address from its address is 1. If the most significant bit of the result value determined by subtracting the corresponding node's address from its address is 1, the two nodes may never simultaneously change the slots since the most significant bit of the result value determined by subtracting its address from the corresponding node's address is always 0. When two nodes are selected at random, the probability that one node will change the slot is 0.5%, regardless of the size of the address value.

FIG. 9 shows a process in which when time slot intervals partially overlap as nodes in two groups approach each other, a pertinent node adjusts its time slot interval to solve any possible problems according to an embodiment of the present invention. In FIG. 9, nodes 801, 802 and 803 belong to a group A, and nodes 804, 805 and 806 belong to a group B. Data streams 811, 812 and 813 correspond to the nodes 801, 802 and 803, respectively. Data streams 814, 815 and 816 correspond to the nodes 804, 805 and 806, respectively. Intervals represented in the same patterns as these of associated nodes on the data streams show time slot intervals occupied by the nodes.

As shown in FIG. 9, time slot intervals of the nodes in the group A do not overlap each other, and time slot intervals of the nodes in the group B also do not overleap each other. However, comparing both groups, since time slot intervals of the nodes 801 and 802 and the nodes 805 and 806 overlap, collisions may occur during data transmission. Thus, each of the nodes accurately identifies each other's time slot schedule by determining a time offset between nodes, and reallocates the time slot in the non-overlapping time intervals, according to the present invention. The respective nodes do not have to perform time synchronization according to the present invention. In the example of FIG. 9, the nodes 803 and 806 readjust their time slot intervals.

Two nodes may exist within the mutual interference range without existing in an area where they can communicate with each other directly or through multiple hops. In this case, the two nodes do not know each other's schedule information despite existing in the mutual interference range, causing possible collisions between packets from the two nodes. Considering this situation, in the present invention, a transmission scheme, if possible by hardware, is used by which data can be received in a broader range in the case of transmission of the TDMA schedule message compared with the general data transmission. Such a scheme may include transmit power increasing, low-transfer rate transmission, using low-code rate channel coding, using high-reception rate modulation, and a combination thereof.

The TDMA time slots secured according to the above process may be used for intra-piconet communication and inter-master node communication. Because the time slots that the master node has secured considering the time slot schedules of peripheral nodes can be freely used in the piconet, they can be allocated to desired slave nodes by the master node. When the master node first wants communication with the slave node, the master node acquires a time slot and then notifies the slave node of the time slot. When the slave node first wants communication with the master node, the slave node requests the master node to secure the required number of time slots.

Because slave nodes have been time-synchronized on the basis of the master node, the slave nodes need not to maintain their time slot tables or transmit and receive TDMA schedule messages. The slave nodes may reserve time slots by means of the master node, and perform TDMA and CSMA communications with their master node without collisions with other peripheral nodes not belonging to the same piconet, by being notified of time slot schedule information of the peripheral nodes.

Each time the time slot intervals allocated to the slave nodes are changed, the master node notifies the slave nodes of the change to allow the nodes to update the time slot intervals, thereby simplifying operations of the slave nodes.

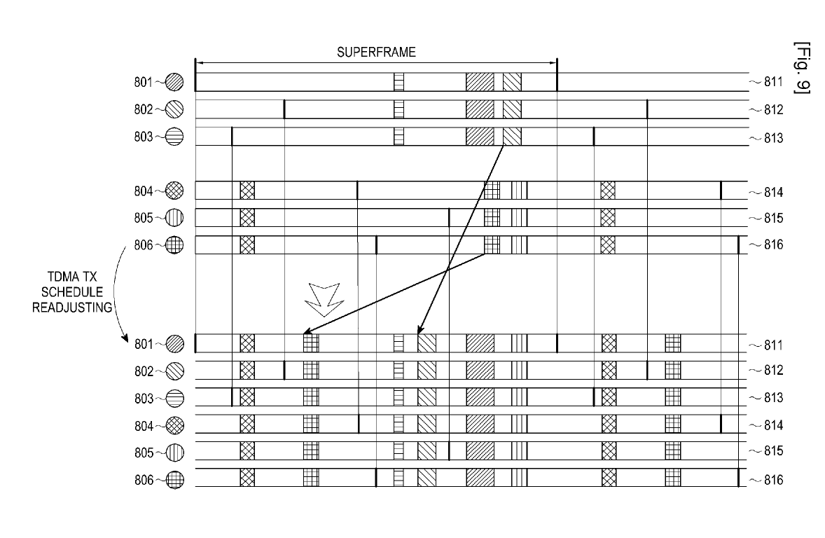

An agreement on the same time slots should be made between the two nodes for communication between master nodes or between independent nodes. Because a time interval available in one node may be unavailable to another node, an agreement process on the time intervals is needed as illustrated in FIG. 8.

Referring to FIG. 8, a data transmission node 610 and a data reception node 620 are independent nodes, and the data transmission node 610 desires to communicate with the data reception node 620.

The data transmission node 610 determines an available time interval by referring to its time slot table in step 701, and transmits a communication request message including the available time interval and a needed time slot length to the data reception node 620 in step 703. The communication request message may include time information of the data reception node 620, and the available time interval may be represented by, for example, time values for starting and ending points of the available time interval.

Upon receiving the communication request message, the data reception node 620 calculates a time offset with the data communication node 610 using the time information of the data transmission node 610, i.e., a timer value of the data transmission node 610. The data reception node 620 changes a time value associated with the available time interval included in the communication request message to a time value based on its timer, using the time offset. In step 705, the data reception node 620 checks time slot information of peripheral nodes referring to its time slot table, to determine the time interval it can use, in common with the data transmission node 610. In step 707, the data reception node 620 allocates a time slot within the determined time interval and updates the time slot table accordingly. In step 709, the data reception node 620 transmits a communication response message including information about the allocated time slot to the data transmission node 610. The communication response message may include time information of the data reception node 620.

Upon receiving the communication response message, the data transmission node 610 calculates a time offset with the data reception node 620, corrects a time value for the allocated time slot interval as a time value based on its timer, and stores it in its time slot table. In step 711, the data transmission node 610 transmits and receives data to/from the data reception node 620 in the allocated time slot interval, performing communication.

The information exchange process of steps 701 to 709 may use CSMA.

While it has been described in FIG. 8 that time information of each node is transmitted along with the communication request message and the communication response message as one example, the time information may also be broadcasted through a separate message.

Although a node uses the time offset to determine a time slot schedule of a relevant node, and to perform TDMA communication with the relevant node in the embodiment described above, the time offset may be applied to all time values that should be determined between nodes for TDMA communication.

As is apparent from the foregoing description, embodiments of the present invention enable efficient TDMA communication in a mobile ad-hoc network and ensure stable mixed communication of CSMA and TDMA. In addition, the present invention can facilitate reliable and effective voice communication and multimedia streaming in the mobile ad-hoc network.

In the above description, the time slot start time and the time slot length are included in the time slot table as entry items, however, a time slot end time may also be included instead of the time slot length, or all three items may be included in an alternative embodiment.

The present invention may enable efficient TDMA communication in the mobile ad-hoc network and ensure stable mixed communication of CSMA and TDMA. In addition, the present invention can facilitate reliable and effective voice communication and multimedia streaming in the mobile ad-hoc network.

While the invention has been shown and described with reference to certain embodiments thereof, it will be understood by those skilled in the art that various changes in form and details may be made therein without departing from the spirit and scope of the invention as defined by the appended claims and their equivalents.

1. A communication method between nodes that have their own timers and have an equal start time of a frame for Time Division Multiple Access (TDMA) communication based on their timers in a mobile ad-hoc network, comprising:
receiving, by a node, a timer value derived by a neighbor node on the basis of a transmission time, from the neighbor node;
calculating a time offset indicative of a difference between a timer value derived on the basis of a time the node received the timer value, and the received timer value, and storing the time offset in a memory; and
upon receiving a time value indicating a time related to inter-node TDMA communication from the neighbor node, correcting the received time value as a time value based on its timer using the time offset, and performing TDMA communication using the corrected time value.

2. The communication method of claim 1, wherein performing TDMA communication comprises:
receiving, from the neighbor node, time slot information including information about at least one time slot allocated to an arbitrary node;
correcting a time value indicating a start time of the at least one time slot, included in the time slot information, as a time value based on its timer using the time offset, and identifying an interval of the at least one time slot on a frame for TDMA communication referring to length information of the at least one time slot, included in the time slot information; and
allocating a time slot to perform TDMA communication to be used by the node in an available time interval except for the interval of the at least one time slot on the frame.

3. The communication method of claim 2, further comprising:
storing a time value for a starting point and length information of the corrected at least one time slot, and a time value for a starting point and length information of the time slot to be used by the node, in the memory as time slot information; and
periodically broadcasting the time slot information to peripheral nodes including the neighbor node.

4. The communication method of claim 3, wherein the time slot information is stored in the memory in the form of a time slot table, the time slot table is composed of entries that are one-to-one mapped to time slots and included in the time slot information, and each of the entries includes an address of a node to which an associated time slot is allocated, a time value for a starting point of the associated time slot, length information of the associated time slot, the number of hops up to a node to which the associated time slot is allocated on the basis of the node, version information indicating an update level, and the time offset.

5. The communication method of claim 4, wherein the periodically broadcasted time slot information includes the entries in the time slot table, and version information of an entry associated with the time slot allocated to the node is adjusted up by one level before the time slot information is broadcasted,
and further comprising:
upon receiving the time slot information in the form of the time slot table from the neighbor node, comparing an entry included in the received time slot information with the entry in the time slot table stored in the memory;
adding a new entry in the time slot table stored in the memory, if a new entry is included in the received time slot information;
if an entry for the same time slot exists among the entry included in the received time slot information and the entry in the time slot table stored in the memory, and version information of the relevant entry included in the received time information among the two entries is greater, updating information of the relevant entry by the time slot table stored in the memory using information included in the relevant entry; and
if an entry for the same time slot exists among the entry included in the received time slot information and the entry in the time slot table stored in the memory, and version information of the two entries is identical, updating information of the relevant entry by the time slot table stored in the memory using information included in the relevant entry, when the number of hops of the relevant entry included in the received time slot informant among the two entries is less.

6. The communication method of claim 3, further comprising adjusting a time slot interval if the at least one time slot overlaps with the time slot allocated to the node.

7. The communication method of claim 6, wherein adjusting the time slot interval comprises readjusting an interval of the time slot allocated to the node by one of the node and the arbitrary node, which has a greater address.

8. The communication method of claim 6, wherein adjusting the time slot interval comprises:
readjusting the interval of the time slot allocated to the node by a node having a greater address if the most significant bit of a result value obtained by subtracting an address of the arbitrary node from an address of the node is 1 and the remaining bits are all 0, and otherwise, readjusting the interval of the time slot allocated to the node by a node, for which the most significant bit of the subtraction result value is 1.

9. The communication method of claim 3, further comprising:
receiving a communication request message from the neighbor node to perform TDMA communication;
correcting a time value indicating an available time interval of the neighbor node, included in the communication request message, as a time value based on its timer using the time offset, and identifying the available time interval of the neighbor node;
comparing the available time interval of the neighbor node with the available time interval of the node, and allocating a time slot having a time slot length included in the communication request message, in an overlapping interval;
transmitting information about the allocated time slot to the neighbor node; and
performing TDMA communication with the neighbor node in the allocated time slot interval.

10. The communication method of claim 3, further comprising:
performing Carrier Sense Multiple Access (CSMA) communication referring to the time slot information stored in the memory,
wherein performing CSMA communication comprises:
determining whether a frame interval corresponding to the present time is in an idle state, referring to the time slot information stored in the memory;
calculating a transmission interval from the present time to a transmission completion time based on a length of CSMA data to be transmitted, if the frame interval is in an idle state, determining whether or not the transmission interval overlaps with an interval of the time slot included in the time slot information stored in the memory, and pending the transmission of the CSMA data in the case of overlapping; and
transmitting the CSMA data if the transmission interval does not overlap with the interval of the time slot included in the time slot information stored in the memory.

11. A communication apparatus for performing communication between nodes that have an equal start time of a frame for Time Division Multiple Access (TDMA) communication based on respective timers of each node in a mobile ad-hoc network, comprising:
a timer;
a transceiver for transmitting and receiving data; and
a processor for receiving a timer value derived by a neighbor node on the basis of a transmission time, from the neighbor node by controlling the transceiver, calculating a time offset indicative of a difference between a timer value derived on the basis of a time the node received the timer value by means of the timer, and the received timer value, storing the time offset in a memory, correcting the received time value as a time value based on the timer using the time offset upon receiving a time value indicating a time related to inter-node TDMA communication from the neighbor node, and performing TDMA communication using the corrected time value.

12. The communication apparatus of claim 11, wherein the processor receives, from the neighbor node, time slot information including information about at least one time slot allocated to an arbitrary node, corrects a time value indicating a start time of the at least one time slot, included in the time slot information, as a time value based on the timer using the time offset, identifies an interval of the at least one timeslot on a frame for TDMA communication referring to length information of the at least one time slot, included in the time slot information, and allocates a time slot to be used by the node in an available time interval except for the interval of the at least one time slot on the frame, to perform TDMA communication.

13. The communication apparatus of claim 12, wherein the processor stores a time value for a starting point and length information of the corrected at least one time slot, and a time value for a starting point and length information of the time slot to be used by the node, in the memory as time slot information, and periodically broadcasts the time slot information to the neighbor node.

14. The communication apparatus of claim 13, wherein the processor
receives a communication request message from the neighbor node to perform TDMA communication,
correcting corrects a time value indicating an available time interval of the neighbor node, included in the communication request message, as a time value based on its timer using the time offset, and identifying the available time interval of the neighbor node,
compares the available time interval of the neighbor node with the available time interval of the node, and allocating a time slot having a time slot length included in the communication request message, in an overlapping interval,
transmits information about the allocated time slot to the neighbor node; and
performs TDMA communication with the neighbor node in the allocated time slot interval.

15. The communication apparatus of claim 13, wherein the processor performs Carrier Sense Multiple Access (CSMA) communication referring to the time slot information stored in the memory, and
wherein performing the CSMA communication by the processor, includes
determining whether a frame interval corresponding to the present time is in an idle state, referring to the time slot information stored in the memory,
calculating a transmission interval from the present time to a transmission completion time based on a length of CSMA data to be transmitted, if the frame interval is in an idle state, determining whether or not the transmission interval overlaps with an interval of the time slot included in the time slot information stored in the memory, and pending the transmission of the CSMA data in the case of overlapping, and
transmitting the CSMA data if the transmission interval does not overlap with the interval of the time slot included in the time slot information stored in the memory.
